(19) United States
(12) Patent Application Publication
(10) Pub. No.: US 2024/0294258 A1
(43) Pub. Date: Sep. 5, 2024

(54) PASSENGER CONTROL UNIT SYSTEM

(71) Applicants: THOMPSON AERO SEATING LIMITED, County Armagh (GB); AVIC CABIN SYSTEM CO., LIMITED (HONG KONG), London (GB)

(72) Inventor: Iain GOWDY, Portadown, Craigavon (GB)

(21) Appl. No.: 18/268,165

(22) PCT Filed: Dec. 15, 2021
(86) PCT No.: PCT/EP2021/085878

§ 371 Date: Jun. 16, 2023

(30) Foreign Application Priority Data
Dec. 17, 2020 (GB) 2020062.2

(51) Int. Cl. B64D 11/00; B64D 11/06; H01H 13/83

(52) U.S. Cl. CPC B64D 11/00155; B64D 11/0639; H01H 13/83

(57) ABSTRACT

A control unit system (40) suitable for an aircraft seat (10) comprises a first control unit (42) with first user-operable input devices (44), and a second control unit (46) with second user-operable input devices (48). The first and second control units are co-operable with one another so that, in response to operation of any one of the first user-operable input devices by a user, a corresponding set (48A, 48B, 48C, 48D) of one or more of said second input devices (48) is operated to adopt the activated state. The control unit system allows a relatively high number of functions to be supported without requiring a large control unit. or complex and expensive hardware or software. Moreover, the system is relatively simple to use compared to. for example. a control unit with a large number of user input buttons or a complex human-computer interface.

### FIELD OF THE INVENTION

This invention relates to control unit systems. The invention relates particularly to passenger control unit systems for vehicles, especially aircraft.

### BACKGROUND TO THE INVENTION

In modern vehicles, particularly in premium class cabins of aircraft, passengers are able to control an increasing number of functions relating to their environment. To this end, passenger seating may be provided with a passenger control unit (PCU) that allows the passenger to control functions such as seat position, lighting, ventilation, climate control and so on. However, the space available for a PCU is usually limited and this restricts the number of user input buttons that can be provided. As a result, the PCU either has to offer a limited set of functions to the user, or be configured to support a human-computer interface that is relatively complex and expensive.

It would be desirable to provide a control unit system that mitigates the problems outlined above.

### SUMMARY OF THE INVENTION

From a first aspect, the invention provides a control unit system comprising: a first control unit having a plurality of first user-operable input devices; a second control unit having a plurality of second user-operable input devices, each of said second user-operable input devices being operable between an activated state and a deactivated state, wherein said first and second control units are co-operable with one another so that, in response to operation of any one of said first user-operable input devices by a user, a corresponding set of one or more of said second input devices is operated to adopt the activated state.

Preferably, in the activated state, the respective second input device is illuminated, or is otherwise caused to have increased invisibility with respect to the deactivated state.

Preferably, in the deactivated state, the respective second input device is not illuminated, or is otherwise caused to have decreased visibility with respect to the activated state, or is hidden.

Optionally, at least some of, preferably all of, said first and second user-operable input devices are touch-sensitive user input devices.

Preferably, each second user input device includes, or is co-operable with, means for illuminating the respective second user input device.

Typically, each of said sets comprises a respective different set of one or more of said second input devices, and wherein, optionally, each second input device belongs to only one set.

Preferably, the, or each, second input device of each set are grouped together spatially on said second control unit.

Optionally, the sets are spaced-apart from one another on said second control unit.

Optionally, the, or each, second input device of each set are arranged in a single row. Optionally, all of said second input devices are arranged in a single row.

Preferred embodiments include a controller in communication with said first and second user control units, said first and second control units being co-operable with one another via said controller.

The controller may be configured to receive control signals from said first control unit and to, in response to receiving a control signal from said first control unit corresponding to operation of any one of said first user-operable input devices by a user, cause said corresponding set of one or more of said second input devices to adopt the activated state.

The controller may be configured to receive control signals from said second control unit and to, in response to receiving a control signal from said second control unit corresponding to operation of any one of said second user-operable input devices that is in the activated state, perform one or more control operations supported by the control unit system.

In preferred embodiments, each of said first input devices is associated with a function type, and each of the second input devices of the corresponding set is associated with a respective function of the respective function type.

Preferably, the system is configured so that only one set of second input devices is activated at any one time.

Preferably, said controller is configured to cause second input devices that do not belong to the set associated with an operated first input device to be in the deactivated state, and/or to be de-illuminated or non-illuminated.

From a second aspect, the invention provides a seat unit comprising a seat, preferably a seat surround structure, and a control unit system according to the first aspect of the invention.

In typical embodiments, said one or more control operations involve causing one or more functions relating to said at least one seat, and/or relating to the seat surround structure to be performed.

Typically, said seat unit includes at least one controllable device, said controller being in communication with said at least one controllable device, and wherein said one or more control operations involve controlling one or more of said at least one controllable device to perform said one or more functions, and wherein said at least one controllable device optionally comprises any one or more of: at least one actuator, at least one light source; at least one heater, at least one cooler; at least one media player.

Said first control unit may incorporated into said seat, for example into an armrest or a seat support structure, or into said seat surround structure, for example into a console, or an armrest or a divider wall.

Said second control unit may be incorporated into said seat, for example into an armrest or a seat support structure, or into said seat surround structure, for example into a console, or an armrest or a divider wall.

Said second input devices may be incorporated into said seat, for example into an armrest or a seat support structure, or into said seat surround structure, for example into a console, or an armrest, or a divider wall, and preferably form part of, or are incorporated into, a surface of the seat or of the seat surround structure.

Preferably, said second input devices are incorporated into a surface of the seat unit, and wherein a respective light source is located behind each second input device, the second input devices being at least partly translucent such that each second input device is backlit when the respective light source is on.

Optionally, said second input devices are arranged in a row that is disposed horizontally or substantially horizontally with respect to the floor on which the seat unit is installed in use.

In preferred embodiments, said seat unit is an aircraft seat unit.

Preferred embodiments of the invention are advantageous in that a relatively high number of functions are supported without requiring a large PCU, or complex and expensive hardware or software. Moreover, the preferred system is relatively simple to use compared to, for example, a PCU with a large number of user input buttons or a complex human-computer interface.

Preferably, said first input devices are incorporated into said seat, for example into an armrest or seat support structure, or into said seat surround structure, for example into a console or divider wall or privacy wall, and preferably form part of, or are incorporated into, a surface of the seat or of the seat surround structure.

### BRIEF DESCRIPTION OF THE DRAWINGS

An embodiment of the invention is now described by way of example and with reference to the accompanying drawings in which:

FIG. 1 is a perspective view of a seat unit embodying one aspect of the invention, and including a control unit system embodying another aspect of the invention;

FIG. 2 is a block diagram of a preferred embodiment of the control unit system; and

FIG. 3A to FIG. 3D illustrate a preferred embodiment of first and second control units being part of the control unit system.

### DETAILED DESCRIPTION OF THE DRAWINGS

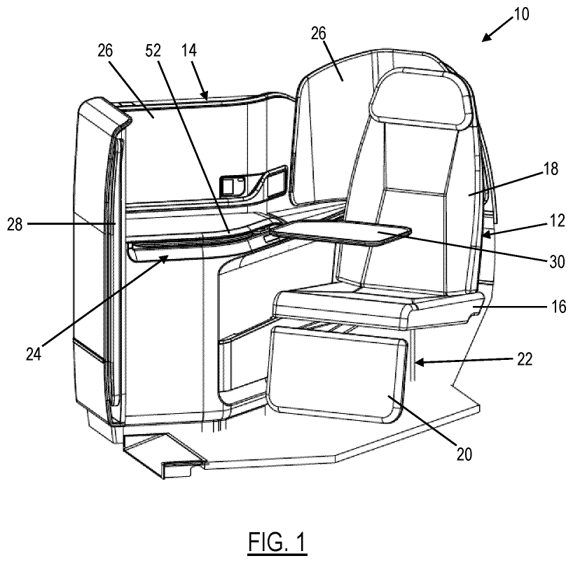

Referring now to FIG. 1 of the drawings there is shown, generally indicated as 10, a seat unit embodying one aspect of the invention. In preferred embodiments, the seat unit 10 is an aircraft seat unit. In alternative embodiments (not illustrated), the seat unit may be adapted for use in other environments, especially vehicles such as trains, coaches, boats or cars.

In preferred embodiments, the seat unit 10 comprises a seat 12 and a seat surround structure 14. The seat 12 comprises a seat pan 16, a seat back 18, typically a leg rest 20, and is usually supported by a seat support structure 22. The support structure 22 can take any suitable form, typically comprising one or more frames and/or support members (not shown). The seat 12 typically also includes one or more actuators (not shown in FIG. 1) that are operable to move the seat 12 and/or any of its component parts 16, 18, 20. For example, the actuators may be configured to move the seat 12 forwards and rearwards, and/or to move the seat 12 between an upright state (as shown in FIG. 1 and commonly referred to as the tax, take-off and landing (TTL) position) and one or more reclined states (which may include a bed state). The seat 12 may include one or more armrest, although in the illustrated embodiment armrest(s) are provided by the surround structure 14.

The seat surround structure 14 may take a variety of different forms, typically including one or more seat console 24 and one or more privacy walls/dividers 26 and optionally a door 28. Typically, the surround structure 14 includes a deployable tray 30, which may be stowed in the console 24 when not in use. The seat unit 10 typically includes a plurality of user controllable devices (not shown) including any one or more of media player(s), light(s), climate control device(s) (including ambient temperature control device(s) and/or seat temperature control device(s)), call button(s) and actuation mechanism(s) (e.g. for deploying/stowing a screen or the tray, or opening and/or closing the door 28 or divider(s) 26. In alternative embodiments, the seat surround structure may be omitted.

It will be apparent from the foregoing that the seat unit 10 provides to a user (not shown) a variety of user controllable functions. The specific combination of user controllable functions provided by the seat unit 10 may vary from embodiment to embodiment, but typically include any one or more of seat movement, lighting control, temperature control, deployment/stowage of utility items and operation of dividers or doors as applicable.

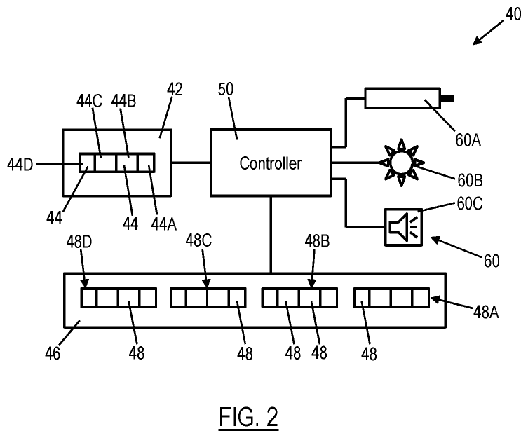

To enable the user to control the available functions, the seat unit 10 includes a control unit system 40 (FIG. 2). The control unit system 40 comprises a first control unit 42 which, in preferred embodiments is a passenger control unit (PCU). The first control unit 42 has a plurality of first user-operable input devices 44. Each input device 44 may take any conventional form, for example a switch, a dial, a push button, a touch-sensitive button or other touch-sensitive input means. The input devices 44 serve as a user interface to facilitate the user in controlling the available functions. The first control unit 42, in particular the input devices 44, is incorporated into or otherwise provided on the seat 12, for example on an armrest or the seat support structure 22, and/or the seat surround structure 14, for example on the console 24, or an armrest, or the divider/privacy wall 26. In preferred embodiments, the input devices 44 form part of, or are incorporated into, a surface of the seat 12 or of the seat surround structure 14. Conveniently, the input devices 44 are incorporated into, or otherwise form part of, a surface of the console 24 (especially a surface of the console 24 that is located beside the seat 12), or the surface of an armrest. Advantageously, the input devices 44 are located within reach of a user when seated in the seat 12. In the illustrated embodiment, four first input devices 44A, 44B, 44C, 44D are shown by way of example, although in other embodiments there may be more or fewer input devices 44.

The control unit system 40 includes a second control unit 46 which, in preferred embodiments is a passenger control unit (PCU). The second control unit has a plurality of second user-operable input devices 48. Each input device 48 may take any conventional form, for example a switch, a dial, a push button, a touch-sensitive button or other touch-sensitive input device. The input devices 48 serve as a user interface to facilitate the user in controlling the available functions. The second control unit 46, in particular the input devices 48, is incorporated into or otherwise provided on the seat 12, for example on an armrest or the seat support structure 22, and/or the seat surround structure 14, for example on the console 24, or an armrest, or the divider/privacy wall 26. In preferred embodiments, the input devices 48 form part of, or are incorporated into, a surface of the seat 12 or of the seat surround structure 14. Conveniently, the input devices 48 are incorporated into, or otherwise form part of, a surface of the console 24 (especially a surface of the console 24 that is located beside the seat 12), or the surface of an armrest. Advantageously, the input devices 44 are located within reach of a user when seated in the seat 12.

In preferred embodiments, the first and second control units 42, 46 are provided as physically separate units, and may spaced apart from each other or located adjacent each other as desired.

Each of the second user-operable input devices 48 is operable between an activated state and a deactivated state. In the activated state, the system 40 is responsive to activation of the input device 48 by the user, whereas in the deactivated state the system 40 is not responsive to activation of the input device 48 by the user, e.g. the input device 48 may be enabled in the activated state and disabled in the deactivated state. This may be achieved by any convenient means.

The first and second control units 42, 46 are co-operable with one another so that, in response to operation of any one of the first user-operable input devices 44A, 44B, 44C, 44D by a user, a corresponding set 48A, 48B, 48C, 48D of one or more of the second input devices 48 is caused to adopt the activated state. Optionally, the system 40 is configured so that only one set of second input devices 48 is activated at any one time. Accordingly, the system 40 may be configured to, in response to operation of any one of the first user-operable input devices 44 by a user, cause any of the second input devices 48 that are not in the set associated with the operated first input device 44 to adopt the deactivated state.

In typical embodiments, the cooperation between the first and second control units 42, 46 is effected by a controller 50. The controller 50 may take any conventional form, for example comprising a suitably programmed microprocessor or microcontroller, or a suitably configured programmable logic controller (PLC) and/or electrical/electronic circuitry. The first and second control units 42, 46 may communicate with the controller 50 by any conventional wired or wireless connection. The controller 50 may be configured to activate or deactivate the second input devices 48 as described above, and this may be achieved in any conventional manner.

In preferred embodiments, when in the activated state, each second input device 48 is illuminated, or is otherwise caused to have increased invisibility with respect to the deactivated state. Similarly, it is preferred that, when in the deactivated state, each second input device 48 is not illuminated, or is otherwise caused to have decreased visibility with respect to the activated state, or is hidden. To this end, in preferred embodiments, each second user input device 48 includes, or is associated with, means for illuminating the respective second user input device 48. The illuminating means can take any conventional form, for example, a lamp, light emitting diode (LED) or other light source (not shown), and may be incorporated into the input device 48 or located behind the input device 48 in order to backlight the input device 48 (in which case the input device 48 may be at least partly translucent).

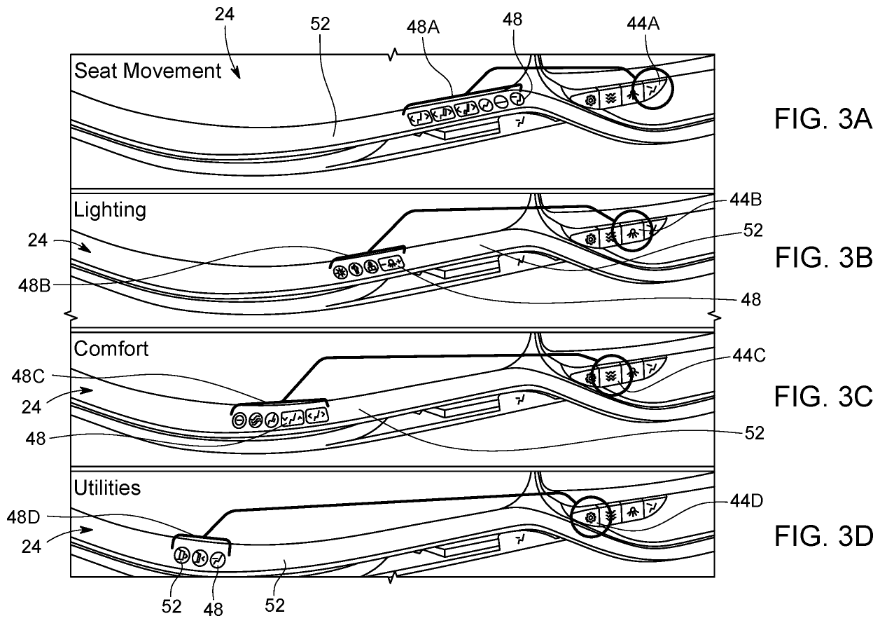

FIGS. 3A to 3D illustrated a preferred embodiment in which the second input devices 48 are incorporated into a surface 52 of the surround structure 14, e.g. a surface of the console 24. The input devices 48 are preferably touch-sensitive input devices (e.g. a capacitive touch button or capacitive touch sensor). Preferably, the touch-sensitive input devices 48 are integrally formed with the surface 52. A respective light source (typically an LED) is located behind each input device 48, i.e. behind the surface 52. The surface 52, or at least the parts of the surface 52 that form the input devices 48, are at least partly translucent such that the input devices 48 are backlit when the respective light source is on. Alternatively, the input devices 48 may be of a push-button type. In any case, the light source may be incorporated into the input device 48 or located behind it as preferred.

It can be seen that in each of FIGS. 3A to 3D a different set 48A, 48B, 48C, 48D of second input devices 48 are illuminated, the other second input devices 48 being non-illuminated.

FIGS. 3A to 3D also show the first input devices 44A, 44B, 44C, 44D, which in this example take the form of push buttons, and which are also incorporated into a surface of the surround structure 14.

In preferred embodiments, each set 48A, 48B, 48C, 48D is comprised of a different group of second input device(s) 48. Typically, each set comprises more than one second input device 48, although it is possible for sets to have only one second input device 48. The number of second input devices 48 in each set can vary from set to set and from embodiment to embodiment. The number of sets may vary from embodiment to embodiment, usually depending on the number of first input devices 44, i.e. in typical embodiments there is a respective set of second input device(s) 48 for each first input device 44. Typically, each second input device 48 belongs to only one set, although it is possible for any given second input device 48 to belong to more than one set.

In preferred embodiments, the second input devices 48 of any given set relate to a respective function associated with a respective function type, and the corresponding first input device 44 relates to the respective function type. For example, in the illustrated embodiment, the first input device 44A relates to a seat movement function type, and the corresponding second input devices 48 of set 48A each relates to a respective seat movement function (e.g. up/down, back/forth, recline, recline-to-bed, adopt TTL); the first input device 44B relates to a lighting function type, and the corresponding second input devices 48 of set 48B each relates to a respective lighting function (e.g. ambient light control, reading light control, call attendant light, dimmer function); the first input device 44C relates to a comfort function type, and the corresponding second input devices 48 of set 48C each relates to a respective comfort function (e.g. do not disturb activation, ambient temperature control, seat temperature control, seat position adjustment); and the first input device 44D relates to a utilities function type, and the corresponding second input devices 48 of set 48D each relates to a respective utilities function (e.g. deployment of tray, deployment of screen, operation of door, operation of media player(s)).

Preferably, the second input devices 48 of each set are grouped together spatially on the second control unit 46. Preferably, the sets are spaced-apart from one another on the second control unit 46, for example being positioned beside, above or below each other. In preferred embodiments, the second input devices 48 of each set are arranged in a single row. It is further preferred that the sets are arranged end-to-end such that all of the second input devices 48 are arranged in a single row. This arrangement, which is illustrated by way of example in FIGS. 3A to 3D, facilitates incorporating the second control unit 42 into the seat 12 or surround structure 14 since narrow, elongate surfaces of the seat 12 or surround structure 14, whether straight or curved, can accommodate the second control unit 46, and such surfaces tend to be more readily available within reach of a seated user than, for example, square surfaces that are large enough to accommodate all of the input devices 48. It is preferred that the second input devices 48 extend in a row that is disposed horizontally or substantially horizontally with respect to the floor on which the seat/seat surround structure is installed in use. Suitable surfaces may include the top, edge or side of an armrest or console. In the illustrated embodiment, the second control unit 42 is provided along a bevelled edge of the console 24. Nevertheless, it will be understood that in alternative embodiments the second input devices 48 may be arranged in any other desired manner.

The first control unit 42 tends to have fewer input devices 44 than the second control unit 46 and so can be accommodated by smaller surface areas. In the illustrated embodiment, the input devices 44 are arranged in a row by way of example.

In use, the operation of any one of the first input devices 44 by a user causes a corresponding control signal to be generated which causes the system 40 to activate the corresponding set of second input devices 48. In the preferred embodiment, the control signal is sent from the first control unit 42 to the controller 50 in response to which the controller 50 causes the relevant second input devices 48 to adopt the activated state. This may be achieved in any conventional manner, for example by enabling the relevant second input devices 48 to generate control signals. In preferred embodiments, the controller 50 also causes the activated second input devices 48 to be illuminated. This may be achieved in any conventional manner, for example by turning on the respective light source. In preferred embodiments, the controller 50 also ensures that all other second input devices 48 that do not belong to the set associated with the operated first input device 44 are in the deactivated state. This may involve disabling and de-illuminating any second input devices 48 that were activated and illuminated in response to a previous operation of another of the first input devices 44. Alternatively, or in addition, the controller 50 may be configured to deactivate and de-illuminate, as applicable, any activated and illuminated, as applicable, second input devices 48 after a period of time has elapsed since their activation/illumination.

When any given set of second input devices 48 is in the activated state, the operation of any one of the corresponding second input devices 48 by a user causes a corresponding control signal to be generated which causes the system 40 to perform one or more associated control operations. In the preferred embodiment, the control signal is sent from the second control unit 46 to the controller 50 in response to which the controller 50 performs the relevant control operation(s). When any set of second input devices 48 is in the deactivated state, the controller 50 may be configured to ignore any corresponding control signals, or to disable the generation of the control signals as is convenient.

The control operations that are supported by the control unit system 40 and which are performed in response to operation of any of the second input devices 48 may vary from embodiment to embodiment. Typically, the control unit system 40 includes or is in communication with (e.g. by any convenient wired or wireless connection) at least one controllable device 60 with which the controller 50 performs the relevant control operation(s). Any conventional controllable device(s) 60 may be used as required by the embodiment. With reference to FIG. 2, the controllable devices 60 may include any one or more of: at least one actuator 60A; at least one environmental control device 60B (e.g. heater(s), cooler(s), fan(s), light(s)); and/or at least one media player 60C. The controller 50 may perform the relevant control operation(s) using the relevant controllable device(s) 60 in order to implement the function(s) corresponding with the operated second input device 48. In preferred embodiments, the controllable devices 60 are coupled to or incorporated into the seat 12 or seat surround structure 14 as applicable in order to implement the various functions that are made available to the user by the control unit system 40.

By way of example, should the user wish to move the seat 12, he or she first operates the first input device 44A of the first control unit 42 that corresponds to the seat movement function type. In response to operation of the first input device 44A, the controller 50 causes the corresponding set of second input devices 48A to be activated and illuminated (or otherwise to have increased visibility with respect to the other second input devices 48B, 48C, 48D). The controller 50 may also cause the other second input devices 48B, 48C, 48D to be deactivated and/or to have reduced visibility with respect to the second input devices 48A. The user may then operate any one or more of the activated second input devices 48A that corresponds to the seat movement function that he or she wishes to be performed (e.g. up/down, back/forth, recline, recline-to-bed, adopt TTL). In response to operation of the relevant second input device(s) 48A, the controller 50 operates the relevant actuator(s) 60A that effect the desired seat movement. Should the user subsequently wish to adjust the lighting, he or she first operates the first input device 44B of the first control unit 42 that corresponds to the lighting function type. In response to operation of the first input device 44B, the controller 50 causes the corresponding set of second input devices 48B to be activated and illuminated (or otherwise to have increased visibility with respect to the other second input devices 48A, 48C, 48D). The controller 50 may also cause the other second input devices 48A, 48C, 48D to be deactivated and/or to have reduced visibility with respect to the second input devices 48B. The user may then operate any one or more of the activated second input devices 48B that corresponds to the lighting function that he or she wishes to be performed (e.g. up/down, back/forth, recline, recline-to-bed, adopt TTL). In response to operation of the relevant second input device(s) 48B, the controller 50 operates the relevant lighting device 60B that implement the desired lighting function. It will be understood that the same or similar procedure may be performed in respect of any of the functions supported by the control unit system 40.

In preferred embodiments in which the seat 12 is an aircraft seat, the preferred system 40 comprises a secondary Passenger Control Unit (PCU) 46 (which may also be referred to as a Comfort Control Unit (CCU)) that is activated by operating an input 44 of a main PCU/CCU 42. When the main PCU 42 button is operated, a corresponding set of secondary PCU 46 menu buttons 48 appear on the console 24 of the seat 12 or other area of the seat, and are illuminated. The buttons 48 are preferably only active after a corresponding main PCU button 44 is operated.

In typical applications, including aircraft seating, there is limited space available for providing control units such as PCUs/CCUs, and this tends to restrict the number of functions that can be made available to the user. Preferred embodiments of the invention allow user input devices (typically buttons) to be provided in a distributed and uncluttered manner that is space-efficient, clear to the user and simple to operate.

The invention is not limited to the embodiment(s) described herein but can be amended or modified without departing from the scope of the present invention.

1. A control unit system comprising:
a first control unit having a plurality of first user-operable input devices; and
a second control unit having a plurality of second user-operable input devices, each of said second user-operable input devices being operable between an activated state and a deactivated state,
wherein said first and second control units are co-operable with one another so that, in response to operation of any one of said first user-operable input devices by a user, a corresponding set of one or more of said second user-operable input devices is operated to adopt the activated state.

2. The control unit system of claim 1, wherein each second user-operable input device includes, or is co-operable with, an illuminating device illuminating the respective second user-operable input device, and wherein, in the activated state, the respective second user-operable input device is illuminated, or is otherwise caused to have increased invisibility with respect to the deactivated state and wherein, in the deactivated state, the respective second user-operable input device is not illuminated, or is otherwise caused to have decreased visibility with respect to the activated state, or is hidden.

3. (canceled)

4. The control unit system of claim 1, wherein at least some of said first and second user-operable input devices are touch-sensitive user input devices.

5. (canceled)

6. The control unit system of claim 1, wherein each of said sets comprises a respective different set of one or more of said second user-operable input devices, and wherein, optionally, each second user-operable input device belongs to only one set.

7. The control unit system of claim 1, wherein the, or each, second user-operable input device of each set are grouped together spatially on said second control unit, and wherein, optionally, the sets are spaced-apart from one another on said second control unit.

8. (canceled)

9. The control unit system of claim 1, wherein the, or each, second user-operable input device of each set are arranged in a single row and wherein, optionally, all of said second user-operable input devices are arranged in a single row.

10. (canceled)

11. The control unit system of claim 1, further including a controller in communication with said first and second user control units, said first and second control units being co-operable with one another via said controller and wherein said controller is configured to receive control signals from said first control unit and to, in response to receiving a control signal from said first control unit corresponding to operation of any one of said first user-operable input devices by a user, cause said corresponding set of one or more of said second user-operable input devices to adopt the activated state.

12. (canceled)

13. The control unit system of claim 11, wherein said controller is configured to receive control signals from said second control unit and to, in response to receiving a control signal from said second control unit corresponding to operation of any one of said second user-operable input devices that is in the activated state, perform one or more control operations supported by the control unit system.

14. The control unit system of claim 1, wherein each of said first user-operable input devices is associated with a function type, and each of the second user-operable input devices of the corresponding set is associated with a respective function of the respective function type.

15. The control unit system of claim 1, wherein the control unit system is configured so that only one set of second user-operable input devices is activated at any one time.

16. . The control unit system of claim 11, wherein said controller is configured to cause second user-operable input devices that do not belong to the set associated with an operated first user-operable input device to be in the deactivated state, and/or to be de-illuminated or non-illuminated.

17. A seat unit comprising a seat having a seat surround structure, and a control unit system, the control unit system comprising:
a first control unit having a plurality of first user-operable input devices; and
a second control unit having a plurality of second user-operable input devices, each of said second user-operable input devices being operable between an activated state and a deactivated state,
wherein said first and second control units are co-operable with one another so that, in response to operation of any one of said first user-operable input devices by a user, a corresponding set of one or more of said second user-operable input devices is operated to adopt the activated state.

18. The seat unit of claim 17, wherein the control unit includes a controller in communication with said first and second user control units, said first and second control units being co-operable with one another via said controller wherein said controller is configured to receive control signals from said second control unit and to, in response to receiving a control signal from said second control unit corresponding to operation of any one of said second user-operable input devices that is in the activated state, perform one or more control operations supported by the control unit system, and wherein said one or more control operations involve causing one or more functions relating to said at least one seat, and/or relating to the seat surround structure to be performed.

19. The seat unit of claim 18, wherein said seat unit includes at least one controllable device, said controller being in communication with said at least one controllable device, and wherein said one or more control operations involve controlling one or more of said at least one controllable device to perform said one or more functions, and wherein said at least one controllable device optionally comprises any one or more of: at least one actuator, at least one light source; at least one heater, at least one cooler; or at least one media player.

20. The seat unit of claim 17, wherein said first control unit is incorporated into said seat or into said seat surround structure.

21. The seat unit of claim 17, wherein said second control unit is incorporated into said seat or into said seat surround structure.

22. The seat unit of claim 17, wherein said second user-operable input devices are incorporated into said seat or into said seat surround structure, and said second user-operable input devices form part of, or are incorporated into, a surface of the seat or of the seat surround structure.

23. The seat unit of claim 17, wherein said second user-operable input devices are incorporated into a surface of the seat unit, and wherein a respective light source is located behind each second user-operable input device, the second user-operable input devices being at least partly translucent such that each second user-operable input device is backlit when the respective light source is on.

24. The seat unit of claim 17, wherein said second user-operable input devices are arranged in a row that is disposed horizontally or substantially horizontally with respect to the floor on which the seat unit is installed in use.

25. The seat unit of claim 17, wherein said seat unit is an aircraft seat unit.
